(19) United States
(12) Patent Application Publication
(10) Pub. No.: US 2024/0067799 A1
(43) Pub. Date: Feb. 29, 2024

(54) ESTERIFICATION METHOD FOR IMPROVING DISPERSIBILITY OF HYDROXYL-CONTAINING NANO-MATERIAL

(71) Applicant: SMART LIQUID CRYSTAL TECHNOLOGIES CO., LTD., Jiangsu (CN)

(72) Inventors: Jiabin WANG, Jiangsu (CN); Wei ZHU, Jiangsu (CN); Yichen ZHANG, Jiangsu (CN); Yao WANG, Jiangsu (CN); Jiayue NIU, Jiangsu (CN)

(73) Assignee: SMART LIQUID CRYSTAL TECHNOLOGIES CO., LTD., Jiangsu (CN)

(21) Appl. No.: 18/259,723

(22) PCT Filed: Oct. 28, 2021
(86) PCT No.: PCT/CN2021/127063

§ 371 Date: Jun. 28, 2023

(30) Foreign Application Priority Data
Dec. 29, 2020 (CN) 202011586473.6

(51) Int. Cl. C08K 5/04; C08K 5/00; C08K 5/17; C08K 9/04

(52) U.S. Cl. CPC C08K 5/04; C08K 5/0016; C08K 5/17; C08K 9/04; C08K 2201/011

(57) ABSTRACT

An esterification method for improving the dispersibility of a hydroxyl-containing nano-material is disclosed herein. The method comprises: S1, thoroughly stirring and uniformly mixing a hydroxyl-containing nano-material precursor and an organic solvent to obtain a mixture; S2, heating and fully pre-reacting the mixture in step S1; and S3, adding an acyl halide to the solution which is heated and fully pre-reacted in step S2, and then further reacting same to finally obtain a surface-modified hydroxyl-containing nano-material. After the hydroxyl-containing nano-material is subjected to a surface modification by using the acyl halide, the dispersibility of the hydroxyl-containing nano-material is effectively improved, and the modified hydroxyl-containing nano-material is not agglomerated when energized with an applied voltage for a long time and is kept stable; the esterification modification method does not have a great influence on the structure of the nano-material, and the esterification modification method does not require harsh water-free and oxygen-free conditions.

### CROSS-REFERENCE TO RELATED APPLICATION(S)

This application claims priority to Chinese Patent Application No. 202011586473.6 filed Dec. 29, 2020 entitled “Esterification method for improving dispersibility of hydroxyl-containing nanomaterial”, the disclosure of which is incorporated herein by reference in its entirety.

### TECHNICAL FIELD

The present application relates to the technical field of nanomaterials, and in particular to an esterification method for improving the dispersibility of a hydroxyl-containing nanomaterial.

### BACKGROUND

In recent years, with the remarkable development of nanotechnology, nanoparticles have been applied not only in industry but also in civil field gradually. More and more novel products based on nanomaterials are appearing in the market, and the application has involved the scientific fields of light, electricity, magnetism, biology and so on. However, there is also a great challenge in the application of nanoparticles, that is, the agglomeration of nanoparticles. The biggest negative influence brought by the agglomeration is the performance reduction of nanomaterials. Specifically, the agglomeration of nanoparticles causes the growth and increase of nanoparticles, thereby affecting the efficiency and performance of nanomaterials. In addition, agglomeration will affect the storage and transportation of nanomaterials, which will greatly shorten the service life of nanomaterials, and the service conditions will be more stringent.

The reasons for the agglomeration of nanoparticles can be summarized as follows: 1. large quantities of charge are accumulated on the surface of nanoparticles and gather together on the particle surface, thus causing the agglomeration; 2. hydrogen bonding between the nanoparticles cause the particles to attract each other and agglomerate; 3. the Van der Waals force between the nanoparticles is higher than the gravity of the nanoparticles themselves, resulting in attraction and agglomeration; 4. the nanoparticles has too high surface energy to be stable, and thereby are prone to agglomeration for reaching a stable state; 5. charge transfer, quantum tunneling effect and the interface atom coupling of the nanoparticles will cause the interfacial interaction between the particles and agglomeration accordingly. The common methods to solve the agglomeration of nanoparticles can be divided into physical method and chemical method based on principle. The physical method mainly includes water removal, deflocculant addition, mechanical dispersion, and ultrasonic dispersion, the advantages of which lie in that the composition, structure, and properties of the nanoparticles will not be influenced, but the physical method has the limitation that the nanoparticles may re-agglomerate during the storage, transportation and use. Compared with the physical method, the chemical method hinders the agglomeration of the nanoparticles mainly by improving the surface chemical properties of the nanoparticles through surface modification, thereby improving the dispersibility of the nanoparticles in media such as dispersing solvents, plasticizers and others. The chemical method mainly includes surface graft reaction method, esterification reaction method, coupling agent method and vapor deposition method, among which graft reaction method and esterification reaction method are the most commonly used methods. The main principles of these two methods are both based on the reaction of active functional groups (such as hydroxyl, carboxyl, amino, etc.) on the nanomaterial surface to achieve surface modification. For the nanomaterials mainly having hydroxyl on the surface, the esterification reaction method is applied more frequently than the graft reaction method. Compared with the graft modification method which uses polymerization monomers as a raw material, the esterification reaction can accurately control the length of surface-modified organic segments, because the modified segments, whether small molecules or oligomers, all have a fixed length. For example, Polymer, 2009, 50, 4552-4563, Dufresne et al. graft different lengths of the alkyl chain to hydroxyl groups on the surface of cellulose by esterification reaction under water-free and oxygen-free conditions, thereby improving the dispersibility in an organic phase, and additionally, the modified nanocrystals basically maintain the original morphology. Dufresne et al. (Biomacromolecules, 2009, 10, 425-432) use isocyanates with different chain lengths as raw materials to modify the nanomaterial through esterification reaction with hydroxyl, so that the dispersibility of the nanomaterial in acetone is significantly improved.

It can be seen that the main strategy to improve the dispersibility of the nanomaterial having hydroxyl on the surface is to modify the nanoparticles through post-esterification reaction. In this process, water and oxygen are usually required to be blocked out, the conditions are strict and the steps are tedious. Moreover, it is still a challenge to inhibit the agglomeration of nanoparticles under an electric field.

### SUMMARY

The present application mainly solves the defects of esterification modification for nanoparticles and provides a method for improving the dispersibility of a nanomaterial having hydroxyl on the surface. In this method, nanoparticles are directly subjected to esterification modification on the surface in the process of synthesizing a polyhydroxy nanomaterial, which not only has low cost and simple process but also effectively grafts organic small molecules on the surface of nanoparticle, and thus the nanoparticles do not agglomerate under electricity for a long time, and the nanomaterial is greatly improved in stability and service life.

In order to achieve the objects, the present application provides an esterification method for improving the dispersibility of the hydroxyl-containing nanomaterials, which includes the following steps: S1. thoroughly stirring and uniformly mixing a hydroxyl-containing nanomaterial precursor and an organic solvent to obtain a mixture; S2. subjecting the mixture in step S1 to heating and sufficient pre-reaction; and S3. adding acyl halide into a solution after the heating and sufficient pre-reaction in step S2, and further reacting to obtain a surface-modified hydroxyl-containing nanomaterial finally.

As a further improvement of the present application, in step S3, the acyl halide is selected from any one of acyl fluoride, acyl chloride, acyl bromide, and acyl iodide.

As a further improvement of the present application, in step S3, the acyl chloride has a single component or mixed components of two or more.

As a further improvement of the present application, the single component is any one of stearoyl chloride, n-valeryl chloride, and dodecanoyl chloride.

As a further improvement of the present application, in step S2, the heating is performed at 30° C. to 120° C.

As a further improvement of the present application, in step S3, the added acyl chloride and the solution after the heating and sufficient pre-reaction have a volume ratio of 1:2 to 1:40.

As a further improvement of the present application, step S3 further includes a step of adding an amine compound into the solution after the heating and sufficient pre-reaction in step S2.

As a further improvement of the present application, the amine compound is triethylamine.

To achieve the above objects, the present application also provides a surface-modified hydroxyl-containing nanomaterial, which is prepared by the esterification method for improving the dispersibility of a hydroxyl-containing nanomaterial.

To achieve the above objects, the present application also provides a light modulating device, which includes a first transparent substrate, a first transparent conductive layer, a light modulating layer, a second transparent conductive layer and a second transparent substrate arranged in sequence, wherein the light modulating layer includes dispersion liquid and the surface-modified hydroxyl-containing nanomaterial which is suspended in the dispersion liquid.

As a further improvement of the present application, the dispersion liquid includes nitrocellulose and trioctyl trimellitate.

The present application has the following beneficial effects; the present application relates to an esterification method for improving the dispersibility of a hydroxyl-containing nanomaterial, which includes the following steps: S1. thoroughly stirring and uniformly mixing a hydroxyl-containing nanomaterial precursor and an organic solvent to obtain a mixture; S2. subjecting the mixture in step S1 to heating and sufficient pre-reaction; and S3. adding acyl halide into a solution after the heating and sufficient pre-reaction in step S2, and further reacting to obtain a surface-modified hydroxyl-containing nanomaterial finally. By the surface modification of the hydroxyl-containing nanomaterial with acyl halide in the present application, the dispersibility of the hydroxyl-containing nanomaterial is effectively improved, and the modified hydroxy-containing nanomaterial remains stable and do not agglomerate under applied voltage for a long time; at the same time, the esterification modification method will not greatly influence the structure of the nanomaterial, and does not require strict water-free and oxygen-free conditions.

### BRIEF DESCRIPTION OF DRAWINGS

FIG. 1 shows an image from scanning electron microscope characterization of a core-shell composite nanomaterial which has a shell of octadecyl-modified iodine-doped calcium coordination polymer material and a core of DPA-modified hydroxyapatite nanorod;

FIG. 2 shows an infrared spectrum of a core-shell composite nanomaterial which has a shell of octadecyl-modified iodine-doped calcium coordination polymer material and a core of DPA-modified hydroxyapatite nanorod;

FIG. 3 shows a schematic structural diagram of a light modulating device in Example 10;

in figures: 101-first transparent substrate; 102-first transparent conductive layer; 103-light modulating layer; 104-second transparent conductive layer; 105-second transparent substrate; 1031-dispersion liquid; 1032-modified hydroxyl-containing nanomaterial; 100-infrared spectrum line of a core-shell composite nanomaterial which has a shell of iodine-doped calcium coordination polymer material and a core of DPA-modified hydroxyapatite nanorod; 200—a core-shell composite nanomaterial which has a shell of octadecyl-modified iodine-doped calcium coordination polymer material and a core of DPA-modified hydroxyapatite nanorod.

### DETAILED DESCRIPTION

For more clear objects, technical solutions and advantages of the present application, the technical solutions of the present application will be clearly and completely described with reference to embodiments and accompanying drawings of the present application. It is apparent that the described embodiments do not cover all the embodiments but only part of the embodiments of the present application, which are not intended to limit the scope of the present application. Any other embodiments, which are obtained by those skilled in the art based on the embodiments in the present application without creative work, all fall within the scope of the present application.

For the objects that the nanomaterial having hydroxyl groups on the surface is improved in dispersibility and does not agglomerate under continuous electricity for a long time, the present application provides an esterification method for improving the dispersibility of a hydroxyl-containing nanomaterial, which includes the following steps: S1. thoroughly stirring and uniformly mixing a hydroxyl-containing nanomaterial precursor and an organic solvent to obtain a mixture; S2. subjecting the mixture in step S1 to heating and sufficient pre-reaction; and S3. adding acyl halide into a solution after the heating and sufficient pre-reaction in step S2, and further reacting to obtain a surface-modified hydroxyl-containing nanomaterial. In step S3, the acyl halide is selected from any one of acyl fluoride, acyl chloride, acyl bromide, and acyl iodide; in the embodiments of the present application, acyl chloride is selected exemplarily, which refers to the compound containing —C(O)Cl and may be acyl chloride with alkyl chain of various lengths or the small organic molecule with acyl chloride functional group. As a preferred embodiment, in step S3, the acyl chloride has a single component or mixed components of two or more; as a further preferred embodiment, the single component may be, but is not limited to, any one of stearoyl chloride, n-valeryl chloride, and dodecanoyl chloride. As a preferred embodiment, step S3 further includes a step of adding an amine compound into the solution after the heating and sufficient pre-reaction in step S2; as a further preferred embodiment, the amine compound may be, but is not limited to, triethylamine. As a preferred embodiment, in step S2, the heating is performed at 30° C. to 120° C. As a preferred embodiment, in step S3, the added acyl chloride and the solution after the heating and sufficient pre-reaction have a volume ratio of 1:2 to 1:40. As a preferred embodiment, in step S1, the organic solvent may be, but is not limited to, at least one of isoamyl acetate, methanol, and DMF.

To achieve the above objects, the present application also provides a surface-modified hydroxyl-containing nanomaterial, which is prepared by the esterification method for improving the dispersibility of a hydroxyl-containing nanomaterial. As a preferred embodiment, the surface-modified hydroxyl-containing nanomaterial is a core-shell composite nanorod with long alkyl chain modification groups on the surface, which the shell is the iodine-doped coordination polymer of calcium, and the core is hydroxyapatite.

To achieve the above objects, the present application also provides a light modulating device, which includes a first transparent substrate 101, a first transparent conductive layer 102, a light modulating layer 103, a second transparent conductive layer 104 and a second transparent substrate 105 arranged in sequence; the light modulating layer 103 of the light modulating device includes dispersion liquid 1031 and the acyl chloride-modified hydroxyl-containing nanomaterial 1032; the dispersion liquid includes nitrocellulose and trioctyl trimellitate.

In the present application, to verify that acyl chloride has a surface modification effect on the hydroxyl-containing nanomaterial, based on which the agglomeration problem of nanomaterial can be solved, several hydroxyl-containing nanomaterials are selected as typical cases for analysis, and the specific verification methods are described below.

### Preliminary Example 1

0.2 g of Ca(NO₃)₂·4H₂O, 0.3 g of terephthalic acid (BTC), 1.450 g Na₂HPO₄·12H₂O, and 0.035 g NaH₂PO₄·2H₂O were added into 30 mL of a mixed solvent of DMF/H₂O (v:v=1:1). The mixture was stirred at 60° C. for 2 h and then transferred to a hydrothermal reactor. The system was placed in a oven at 200° C. and reacted for 24 h. The reaction product was centrifuged at 9000 r/min and washed with DMF and ultra-pure water each for three times, and BTC-modified hydroxyapatite nanorod was obtained as white solid I.

### Preliminary Example 2

0.2 g of calcium nitrate, 0.3 g of 2,5-pyrazinedicarboxylic acid (DPA), 1.450 g disodium hydrogen phosphate, and 0.035 g sodium dihydrogen phosphate were added into 30 mL of a mixed solvent of DMF/H₂O (v:v=1:1) mixture. The mixture was stirred at 60° C. for 2 h and then transferred to a hydrothermal reactor. The system was placed in a oven at 200° C. and reacted for 24 h. The reaction product was centrifuged at 9000 r/min and washed with DMF and ultra-pure water each for three times, and DPA-modified hydroxyapatite nanorod I l was obtained.

### Comparative Example 1

0.5 g of nickel chloride and 0.8 g of terephthalic acid were dissolved in 40 mL of DMF, and 1 mL of methanol was added. After the mixture was mixed well and subsequently placed in a 100 mL three-necked flask, then reacted at 80° C. for 12 hours. After cooling down, the green solid was centrifuged at 9000 r/min and washed with DMF and ultra-pure water each for three times, and metal-organic coordination polymer of Ni III was obtained.

### Comparative Example 2

0.5 g of nickel chloride and 0.8 g of terephthalic acid were dissolved in 40 mL of DMF, 1 g of the BTC-modified hydroxyapatite nanorods from Preliminary Example 1 was added, then 1 mL of methanol was added. After the mixture was mixed well and subsequently placed in a 100 mL three-necked flask, then reacted at 80° C. for 12 hours. After cooling down, the green solid was centrifuged at 9000 r/min and washed with DMF and ultra-pure water each for three times, and core-shell composite nanomaterial IV was obtained, which had a shell of metal-organic coordination polymer of Ni and a core of BTC-modified hydroxyapatite nanorod.

### Comparative Example 3

3 g of calcium iodide, 2 g of iodine and 4 g of nitrocellulose were dissolved in 40 mL of isoamyl acetate, and then 3 g of 2,5-pyrazinedicarboxylic acid and 4 g of methanol were added sequentially and stirred for 30 min. After the mixture was mixed well and subsequently placed placed in an oil bath at 40° C. and reacted for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium V (i.e., the hydroxyl-containing nanomaterial of this comparative example) was obtained.

### Comparative Example 4

3 g of calcium iodide, 2 g of iodine and 4 g of nitrocellulose were dissolved in 40 mL of isoamyl acetate, 1 g of the DPA-modified hydroxyapatite nanorods from Preliminary Example 2 was added, and then 3 g of 2,5-pyrazinedicarboxylic acid and 4 g of methanol were added in sequence and stirred for 30 min. After the mixture was mixed well and subsequently placed in an oil bath at 40° C. and reacted for 12 h. After cooling down, the reaction product was centrifuged at 2000 r/min to remove the solid; then the rest of the suspension was centrifuged at 10000 r/min; the obtained solid was washed with isoamyl acetate for three times, and core-shell composite nanomaterial VI (i.e., the hydroxyl-containing nanomaterial of this comparative example) was obtained, which had a shell of iodine-doped coordination polymer of calcium and a core of DPA-modified hydroxyapatite nanorod.

### Example 1

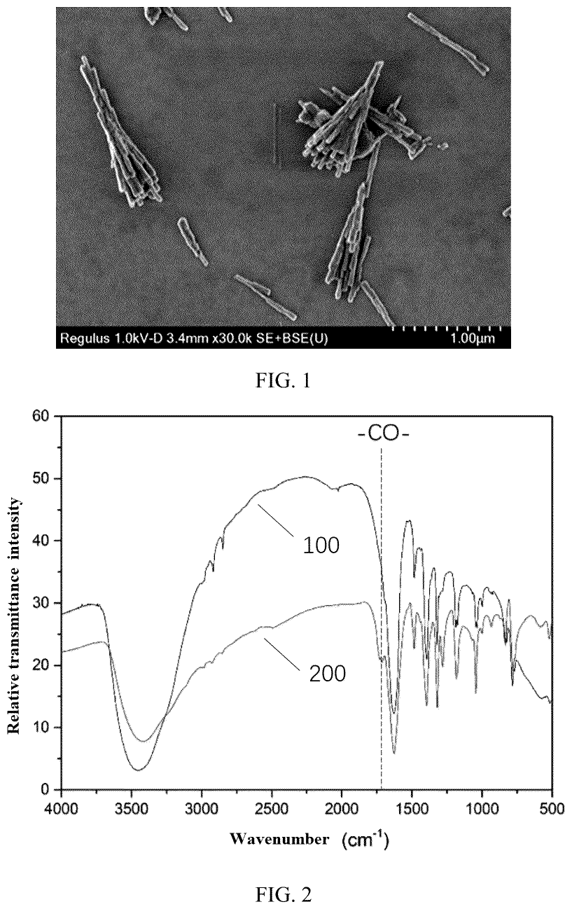

3 g of calcium iodide, 2 g of iodine and 4 g of nitrocellulose were dissolved in 40 mL of isoamyl acetate, 1 g of the DPA-modified hydroxyapatite nanorods from Preliminary Example 2 was added, and then 3 g of 2,5-pyrazinedicarboxylic acid and 4 g of methanol were added and stirred for 30 min. After the mixture was mixed well and subsequently placed in an oil bath at 40° C. and reacted for 1 h. The system was added with 0.5 mL of triethylamine and 1 mL stearoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and core-shell composite nanomaterial VII (i.e., the hydroxyl-containing nanomaterial of this example) was obtained, which had a shell of octadecyl-modified iodine-doped coordination polymer of calcium and a core of DPA-modified hydroxyapatite nanorod; FIG. 1 shows its morphology.

Analysis for Fourier transform infrared spectroscopy (FTIR) of the products from Comparative Example 4 and Example 1: Comparative Example 4 provides the core-shell composite nanomaterial which has a shell of iodine-doped coordination polymer of calcium, without stearoyl chloride modified, and a core of DPA-modified hydroxyapatite nanorod, and Example 1 provides the core-shell composite nanomaterial which has a shell of stearoyl chloride-modified iodine-doped coordination polymer of calcium and a core of DPA-modified hydroxyapatite nanorod; in the present application, FTIR analysis is performed on the products synthesized in Comparative Example 4 and Example 1 individually, and the FTIR spectra are shown in FIG. 2. As shown in FIG. 2, the surface of the product synthesized in Comparative Example 4 shows no obvious carbonyl stretching vibration peak, and the surface of the product synthesized in Example 1 shows obvious carbonyl stretching vibration peak, which indicates that the modification method adopted by the present application is suitable for surface modification of hydroxyl-containing nanomaterials.

### Example 2

3 g of calcium iodide, 2 g of iodine and 4 g of nitrocellulose were dissolved in 40 mL of isoamyl acetate thoroughly, and then 3 g of 2,5-pyrazinedicarboxylic acid and 4 g of methanol were added and then stirred for 30 min. After the mixture was mixed well and subsequently placed in an oil bath at 40° C. and reacted for 1 h. The system was added with 0.5 mL of triethylamine and 1 mL stearoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and the octadecyl-modified iodine-doped coordination polymer of calcium VIII (i.e., the hydroxyl-containing nanomaterial of this example) was obtained.

Comparative Example 3 provides the iodine-doped coordination polymer of calcium without stearoyl chloride modified, and Example 2 provides the stearoyl chloride-modified iodine-doped coordination polymer of calcium; in the present application, FTIR analysis is performed on the products synthesized in Comparative Example 3 and Example 2 individually; the product synthesized in Example 2 shows obvious carbonyl infrared stretching vibration peak, which indicates that the modification method adopted by the present application is suitable for surface modification of hydroxyl-containing nanomaterials.

### Example 3

0.5 g of nickel chloride and 0.8 g of terephthalic acid were dissolved in 40 mL of DMF, and 1 mL of methanol was added. After the mixture was mixed well and subsequently placed in a 100 mL three-necked flask, reacted at 80° C. for 1 hour, then added with 0.5 mL of triethylamine and 1 mL stearoyl chloride directly and continued to react for 12 h. After cooling down, a green solid was centrifuged at 9000 r/min and washed with DMF and ultra-pure water each for three times, and the octadecyl-modified metal-organic coordination polymer of Ni IX (i.e., the hydroxyl-containing nanomaterial of this example) was obtained.

Comparative Example 1 provides the metal-organic coordination polymer of Ni without stearoyl chloride modified, and Example 3 provides the stearoyl chloride-modified metal-organic coordination polymer of Ni; in the present application, FTIR analysis is performed on the products synthesized in Comparative Example 1 and Example 3 individually, and no obvious carbonyl infrared stretching vibration peak change can be observed.

### Example 4

0.5 g of nickel chloride and 0.8 g of terephthalic acid were dissolved in 40 mL of DMF, 1 g of the BTC-modified hydroxyapatite nanorods from Preliminary Example 1 was added, and 1 mL of methanol was added. After the mixture was mixed well and subsequently placed in a 100 mL three-necked flask, reacted at 80° C. for 1 hour, then added with 0.5 mL of triethylamine and 1 mL stearoyl chloride directly and continued to react for 12 h. After cooling down, a green solid was centrifuged at 9000 r/min and washed with DMF and ultra-pure water each for three times, and core-shell composite nanomaterial X was obtained, which had a shell of metal-organic coordination polymer of Ni with octadecyl modified on the surface and a core of BTC-modified hydroxyapatite nanorod.

Comparative Example 2 provides the core-shell composite nanomaterial which has a shell of metal-organic coordination polymer of Ni, without stearoyl chloride modified, and a core of BTC-modified hydroxyapatite nanorod, and Example 4 provides the core-shell composite nanomaterial which has a shell of stearoyl chloride-modified metal-organic coordination polymer of Ni and a core of BTC-modified hydroxyapatite nanorod; in the present application, FTIR analysis is performed on the products synthesized in Comparative Example 2 and Example 4 individually, and no obvious carbonyl stretching vibration peak change can be observed, indicating that a prerequisite for effective modification is the hydroxyl on the nanomaterial surface in the present application.

### Example 5

3 g of calcium iodide, 2 g of iodine and 4 g of nitrocellulose were dissolved in 20 mL of isoamyl acetate, 10 g of the DPA-modified hydroxyapatite nanorods from Preliminary Example 2 was added, and then 3 g of 2,5-pyrazinedicarboxylic acid and 4 g of methanol were added in sequence and stirred for 30 min. After the mixture was mixed well and subsequently placed in an oil bath at 40° C. and reacted for 1 h. Then the system was added with 0.5 mL of triethylamine and 1 mL stearoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium XI (i.e., the hydroxyl-containing nanomaterial of this example) with octadecyl modified on the surface was obtained. It is found by analysis that the amount of the isoamyl acetate solvent in the present application does not affect the surface modification.

### Example 6

3 g of calcium iodide, 2 g of iodine and 4 g of nitrocellulose were dissolved in 20 mL of isoamyl acetate thoroughly, and then 3 g of 2,5-pyrazinedicarboxylic acid and 4 g of methanol were added in sequence and stirred for 30 min. After the mixture was mixed well and subsequently placed in an oil bath at 40° C. and reacted for 1 h. The system was added with 0.5 mL of triethylamine and 1 mL stearoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium XII (i.e., the hydroxyl-containing nanomaterial of this example) with octadecyl modified on the surface was obtained. It is found by analysis that the amount of the DPA-modified hydroxyapatite nanorods in the present application does not affect the surface modification effect of stearyl chloride.

### Example 7

3 g of calcium iodide, 2 g of iodine and 4 g of nitrocellulose were dissolved in 20 mL of isoamyl acetate thoroughly, and then 3 g of 2,5-pyrazinedicarboxylic acid and 4 g of methanol were added in sequence and stirred for 30 min. After the mixture was mixed well and subsequently placed in an oil bath at 40° C. and reacted for 1 h. The system was added with 0.5 mL of triethylamine and 10 mL stearoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium XIII (i.e., the hydroxyl-containing nanomaterial of this example) with octadecyl modified on the surface was obtained. It is found by analysis that increasing the amount of stearyl chloride in the present application does not affect the surface modification effect of stearyl chloride.

### Example 8

3 g of calcium iodide, 2 g of iodine and 4 g of nitrocellulose were dissolved in 20 mL of isoamyl acetate thoroughly, and then 3 g of 2,5-pyrazinedicarboxylic acid and 4 g of methanol were added in sequence and stirred for 30 min. After the mixture was mixed well and subsequently placed in an oil bath at 40° C. and reacted for 1 h. The system was added with 0.5 mL of triethylamine and 10 mL n-valeryl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium i (i.e., the hydroxyl-containing nanomaterial of this example) with n-pentyl modified on the surface was obtained. It is found by analysis that the modification method adopted by the present application is suitable for surface modification of hydroxyl-containing nanomaterials with n-valeryl chloride.

### Example 9

3 g of calcium iodide, 2 g of iodine and 4 g of nitrocellulose were dissolved in 20 mL of isoamyl acetate thoroughly, and then 3 g of 2,5-pyrazinedicarboxylic acid and 4 g of methanol were added in sequence and stirred for 30 min. After the mixture was mixed well and subsequently placed in an oil bath at 40° C. and reacted for 1 h. The system was added with 0.5 mL of triethylamine and 10 mL dodecanoyl chloride directly and continued to react for 12 h. After cooling down, the reaction product was centrifuged at 2000 r/min to remove the solid; then the rest of the suspension was centrifuged at 10000 r/min; the obtained solid was washed with isoamyl acetate for three times, and iodine-doped coordination polymer of calcium ii (i.e., the hydroxyl-containing nanomaterial of this example) with dodecyl modified on the surface was obtained. It is found by analysis that the modification method adopted by the present application is suitable for surface modification of hydroxyl-containing nanomaterials with dodecanoyl chloride.

### Example 10

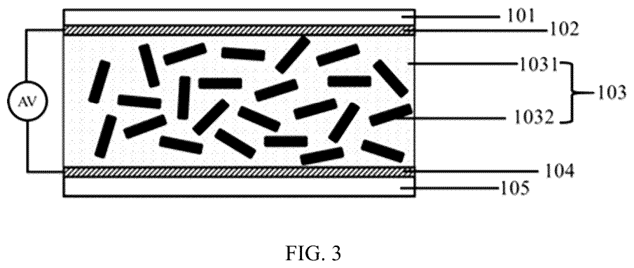

The nanomaterials of Comparative Examples 1-4 and Examples 1-9 were dispersed in trioctyl trimellitate at a mass fraction of 5% to prepare a suspended solution, and the suspended solution was filled into a 20 μm-thick liquid crystal cell, and supplied with continuous electricity of alternating current at 50 V to accelerate the agglomeration of the nanoparticles, as shown in FIG. 3. The stability of the nanomaterials was determined, and the final results were shown in Table 1.

TABLE 1
Stability analysis of nanomaterials in Comparative
Examples 1-4 and Examples 1-9

| Material | Modified group | Stable time | |
|---|---|---|---|
| III | — | 3 | hours |
| IV | — | 3 | hours |
| V | — | 6 | hours |
| VI | — | 6 | hours |
| VII | Octadecyl | 50 | hours |
| VIII | Octadecyl | 50 | hours |
| IX | Octadecyl | 3 | hours |
| X | Octadecyl | 3 | hours |
| XI | Octadecyl | 70 | hours |
| XII | Octadecyl | 70 | hours |
| X III | Octadecyl | 120 | hours |
| i | n-pentanyl | 80 | hours |
| ii | dodecyl | 100 | hours |

In summary, the present application relates to an esterification method for improving the dispersibility of a hydroxyl-containing nanomaterial, which includes the following steps: S1. thoroughly stirring and uniformly mixing a hydroxyl-containing nanomaterial precursor and an organic solvent to obtain a mixture; S2. subjecting the mixture in step S1 to heating and sufficient pre-reaction; and S3. adding acyl chloride into a solution after the heating and sufficient pre-reaction in step S2, and further reacting to obtain a surface-modified hydroxyl-containing nanomaterial. By the surface modification of the hydroxyl-containing nanomaterial with acyl chloride in the present application, the dispersibility of the hydroxyl-containing nanomaterial is effectively improved, the modified hydroxy-containing nanomaterial remains stable and do not agglomerate under applied voltage for a long time. At the same time, the esterification modification method will not greatly influence the structure of the nanomaterial, and does not require strict water-free and oxygen-free conditions.

Although this specification is described through embodiments, it is not suggested that each embodiment only includes one independent technical solution. Such description of the specification is merely for the sake of clarity. Those skilled in the art should consider the specification as a whole, and the technical solutions in various embodiments can be combined appropriately to form other embodiments that can be understood by those skilled in the art.

The series of detailed descriptions hereinbefore are merely specific descriptions of the feasible embodiments of the present application and are not intended to limit the protection scope of the present application. The equivalent embodiments or modifications without departing from the spirit of the present application all fall within the protection scope of the present application.

1. An esterification method for improving the dispersibility of a hydroxyl-containing nanomaterial, comprising the following steps:
S1. thoroughly stirring and uniformly mixing a hydroxyl-containing nanomaterial precursor and an organic solvent to obtain a mixture; and
S2. adding acyl halide into the mixture in step S1 and further reacting to obtain a surface-modified hydroxyl-containing nanomaterial.

2. The esterification method for improving the dispersibility of a hydroxyl-containing nanomaterial according to claim 1, wherein in step S2, the acyl halide is selected from any one of acyl fluoride, acyl chloride, acyl bromide, and acyl iodide.

3. The esterification method for improving the dispersibility of a hydroxyl-containing nanomaterial according to claim 2, wherein in step S2, the acyl chloride has a single component or mixed components of two or more.

4. The esterification method for improving the dispersibility of a hydroxyl-containing nanomaterial according to claim 3, wherein the single component is any one of stearoyl chloride, n-valeryl chloride, and dodecanoyl chloride.

5.-8. (canceled)

9. A surface-modified hydroxyl-containing nanomaterial, which is prepared by the esterification method for improving the dispersibility of a hydroxyl-containing nanomaterial according to claim 1.

10. A light modulating device, comprising a first transparent substrate, a first transparent conductive layer, a light modulating layer, a second transparent conductive layer and a second transparent substrate arranged in sequence.

11. (canceled)

12. The light modulating device according to claim 10, wherein the light modulating layer comprises dispersion liquid and a surface-modified hydroxyl-containing nanomaterial which is dispersed in the dispersion liquid;
wherein the surface-modified hydroxyl-containing nanomaterial is prepared by a esterification method for improving the dispersibility of a hydroxyl-containing nanomaterial;
wherein the esterification method for improving the dispersibility of a hydroxyl-containing nanomaterial comprises the following steps:
(1) thoroughly stirring and uniformly mixing a hydroxyl-containing nanomaterial precursor and an organic solvent to obtain a mixture; and
(2) adding acyl halide into the mixture in step (1), and further reacting to obtain a surface-modified hydroxyl-containing nanomaterial.

13. The light modulating device according to claim 12, wherein the dispersion liquid comprises nitrocellulose and trioctyl trimellitate.

14. The esterification method for improving the dispersibility of a hydroxyl-containing nanomaterial according to claim 1, wherein the method further comprises a step of subjecting the mixture in step S1 to heating and sufficient pre-reaction before step S3.

15. The esterification method for improving the dispersibility of a hydroxyl-containing nanomaterial according to claim 14, wherein the heating is performed at 30° C. to 120° C.

16. The esterification method for improving the dispersibility of a hydroxyl-containing nanomaterial according to claim 14, wherein in step S2, the added acyl chloride and the solution after the heating and sufficient pre-reaction have a volume ratio of 1:2 to 1:40.

17. The esterification method for improving the dispersibility of a hydroxyl-containing nanomaterial according to claim 14, wherein step S2 further comprises a step of adding an amine compound into the solution after the heating and sufficient pre-reaction.

18. The esterification method for improving the dispersibility of a hydroxyl-containing nanomaterial according to claim 17, wherein the amine compound is triethylamine.
